(19) United States
(12) Patent Application Publication
(10) Pub. No.: US 2025/0239106 A1
(43) Pub. Date: Jul. 24, 2025

(54) SYSTEM AND METHOD FOR MODULE AND ANTENNA REPLACEMENT IN CONNECTED VEHICLES AND EQUIPMENT

(71) Applicants: AT&T Intellectual Property I, L.P., Atlanta, GA (US); AT&T Mobility II LLC, Atlanta, GA (US)

(72) Inventors: Rashmi Palamadai, Naperville, IL (US); Peter Wong, Redmond, WA (US); Robert Holden, Allen, TX (US)

(73) Assignees: AT&T Intellectual Property I, L.P., Atlanta, GA (US); AT&T Mobility II LLC, Atlanta, GA (US)

(21) Appl. No.: 18/416,212

(22) Filed: Jan. 18, 2024

(51) Int. Cl. G07C 5/00; B60W 50/02; G06F 8/65; H01Q 1/32; H04W 4/40

(52) U.S. Cl. CPC G07C 5/008; B60W 50/0205; G06F 8/65; H01Q 1/32; H04W 4/40; B60W 2050/021

(57) ABSTRACT

Aspects of the subject disclosure may include, for example, modifying one or more components of a connected vehicle communication system of a vehicle, the connected vehicle communication system operative to communicate vehicle data with network equipment of a service provider over a mobile network of a mobile network operator, confirming operational connectivity among the one or more components of the connected vehicle communication system, communicating to the network equipment of the service provider, information confirming a successful modification of the one or more components of the connected vehicle communication system. Other embodiments are disclosed.

### FIELD OF THE DISCLOSURE

The subject disclosure relates to communication module and antenna replacement in connected vehicles and equipment.

### BACKGROUND

Connected vehicles can communicate data with other equipment and vehicles. The communication is generally by radio transmission and reception. The data may be related to services for passengers, such as music, navigation information and other internet data. The data may be related to vehicle functionality including self-driving abilities, such as coordination with other vehicles and receiving updated information such as traffic information. In a similar fashion, Internet of Things (IoT) devices generally include sensors, processing abilities and the ability to communicate with other devices and systems over networks including the internet.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a connected vehicle control system functioning within the communication network of FIG. 1 in accordance with various aspects described herein.

FIG. 2C is a block diagram illustrating an example, non-limiting embodiment of a network access device in accordance with various aspects described herein.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for updating, reconfiguring, and replacing communication technologies in devices such as connected vehicles and Internet of Things (IoT) devices. Existing devices can communicate using conventional technologies such as cellular or mobile communications. Such technologies include or have included second generation (2G), third generation (3G), fourth generation (4G or LTE) and fifth generation (5G) communications. Sixth generation (6G) mobile networks are anticipated for the year 2030, with additional improvements and capabilities planned for the future.

Such vehicles and devices may communicate the widest range of information including information vehicle passengers such as voice calls, internet data and other data, as well as vehicle data such as telematics data, performance information, vehicle software updates and operational data such as for autonomous vehicles. Such data may originate with the original equipment manufacturer (OEM) which designs and builds the vehicle and maintains and updates software and other aspects of the vehicle. Such data may further originate with a carrier or mobile network operator (MNO) providing information about the communication network to communication devices onboard the vehicle or to the IoT device. For IoT devices, such data may include sensor data shared among devices or communicated to a central location as well as control data received at the IoT device to control the device.

Connected vehicles include personal vehicles and fleet-operated vehicles with a common owner. Connected vehicles may include automobiles and trucks as well as specialty vehicles such as tractors and other agricultural vehicles, watercraft and aircraft. IoT devices may include wireless sensors, control systems, automation devices such as home automation and building automation, and appliances and security systems.

Current connected vehicles and IoT devices, and future-developed vehicles and devices will outlast available communication technologies, as connected vehicle systems and IoT systems are designed for long-term connectivity over many years or decades. New generations of mobility networks and new communication technologies are being rolled out on a much shorter timeframe. Also, the new car development cycle lasts several years before a newly developed vehicle enters production. That may put the vehicle more than half-way through a technology life cycle of the mobility network even when the vehicle is brand new. The vehicle will be sold for several years but vehicles may begin to lose connectivity as the mobility network changes to the next generation. As a result, customers and operators lose the ability to make calls and access the internet and the manufacturer loses access to vehicle data such as telematics data, for example. Moreover, newly available technologies such as 6G, when brought online, will provide features that will be desirable but may be unavailable to existing vehicles and devices.

As communication technology advances, some vehicles and IoT devices are at risk of obsolescence. Current vehicles typically achieve mobile network (cellular) connectivity on an LTE or 4G network provided by a mobile network operator. When existing LTE networks are sunsetted by the carriers and replaced by 5G networks, the current vehicles risk losing connectivity. To maintain connectivity, the hardware and software that establishes connectivity must be updated. However, that updating should be efficiently and easily accomplished with minimal disruption to the vehicle. Previous generations of LTE connection components should be readily replaced by next generation or 5G components so the vehicle can continue to enjoy the benefits of connectivity and perhaps enjoy newly available features of the next generation technology. This is true even for intra-generational updates such as sub-6 GHz transition to millimeter wave (mmWave) spectrum in 5G networks.

Conventionally, users and manufacturers have relied less on connectivity and the information available, and so the urgency to update communications ability has not been so great. Vehicle owners and operators may be unaware of or not reliant on vehicle connectivity, preferring capabilities of a personal mobile device or cell phone. Manufacturers may have decided that telematics information and other information is less valuable after three or four years of vehicle life followed by connectivity obsolescence for the vehicle. These factors have diminished over time and in conjunction with the long life cycle of vehicles and IoT devices relative to mobility technologies.

One or more aspects of the subject disclosure include modifying one or more components of a connected vehicle communication system of a vehicle, the connected vehicle communication system operative to communicate vehicle data with network equipment of a service provider over a mobile network of a mobile network operator, confirming operational connectivity among the one or more components of the connected vehicle communication system, communicating to the network equipment of the service provider, information confirming a successful modification of the one or more components of the connected vehicle communication system.

One or more aspects of the subject disclosure include communicating information about a modification of a connected vehicle communication module associated with a vehicle, wherein the communicating comprises providing data to network equipment of a manufacturer of the vehicle including the connected vehicle communication module, wherein the connected vehicle communication module is operative to provide connected vehicle data to the network equipment of the manufacturer over a mobility network of a mobile network operator, modifying the connected vehicle communication module according to the modification to conform future connected vehicle communications of the connected vehicle communication module to a future mobile communications standard of the mobility network of the mobile network operator, and communicating, to the network equipment of the manufacturer, information confirming a successful modification of the connected vehicle communication module.

One or more aspects of the subject disclosure include communicating vehicle information of a vehicle to a manufacturer of the vehicle, wherein the communicating comprises communicating the vehicle information between a connected vehicle communications system of the vehicle and a mobility network of a mobile network operator, modifying one or more components of the connected vehicle communications system to conform to a next-generation communication standard of the mobility network, forming a modified communications system, automatically confirming operation of the modified communication system, and communicating to the manufacturer of the vehicle information about the modified communications system.

Other embodiments are described in the subject disclosure.

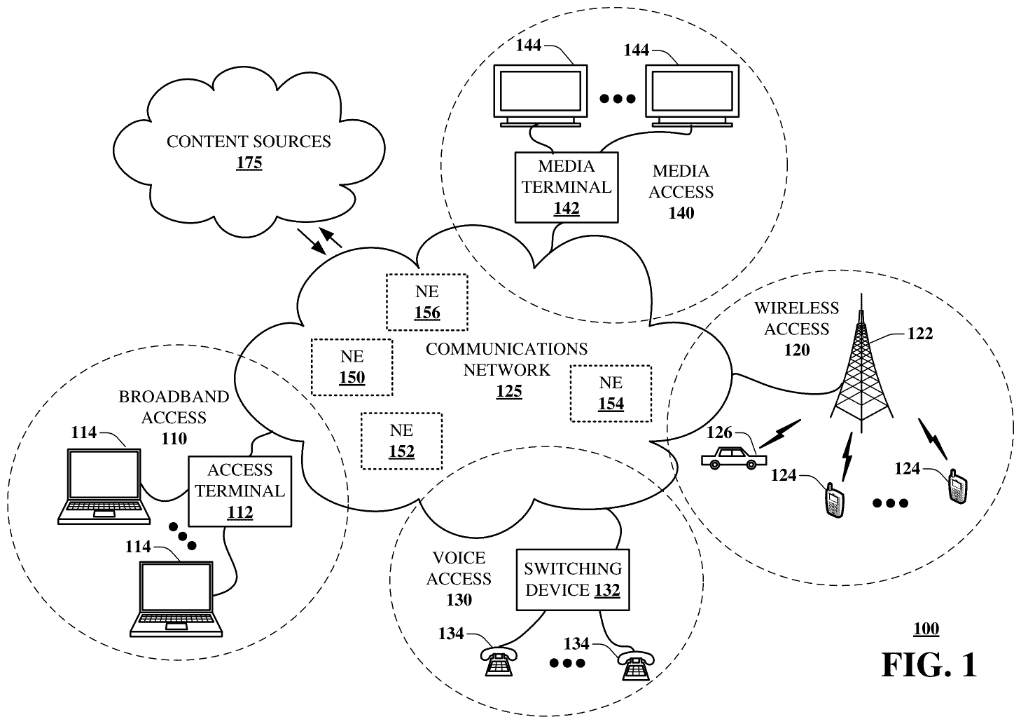

Referring now to FIG. 1, a block diagram is shown illustrating an example, non-limiting embodiment of a system 100 in accordance with various aspects described herein. For example, system 100 can facilitate in whole or in part communicating vehicle data of a vehicle or Internet of Things (IoT) device data to a remote location such as a manufacturer, modifying communications components to enable future communications on a next-generation mobile network, and automatically confirming the modification. In particular, a communications network 125 is presented for providing broadband access 110 to a plurality of data terminals 114 via access terminal 112, wireless access 120 to a plurality of mobile devices 124 and vehicle 126 via access point or base station 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the access point or base station 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

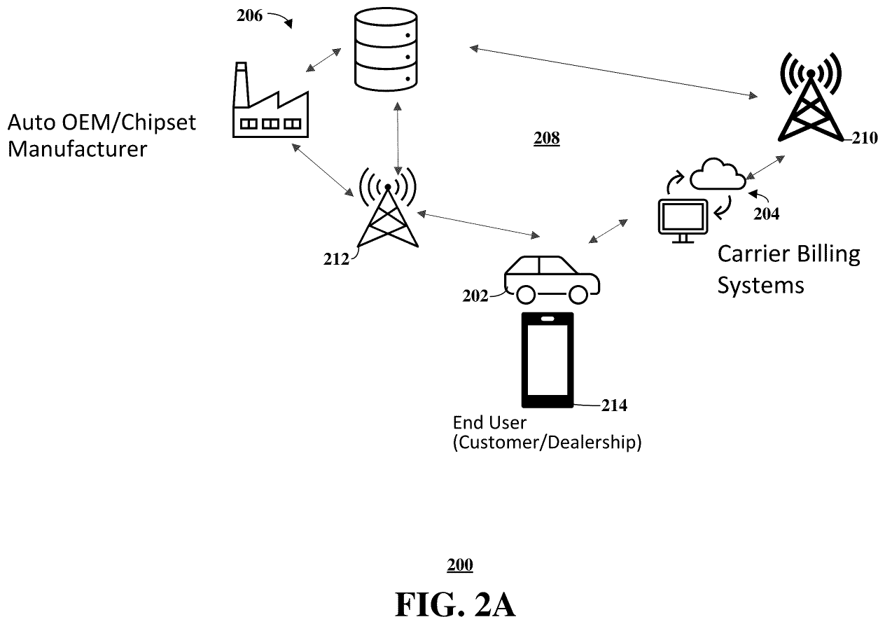

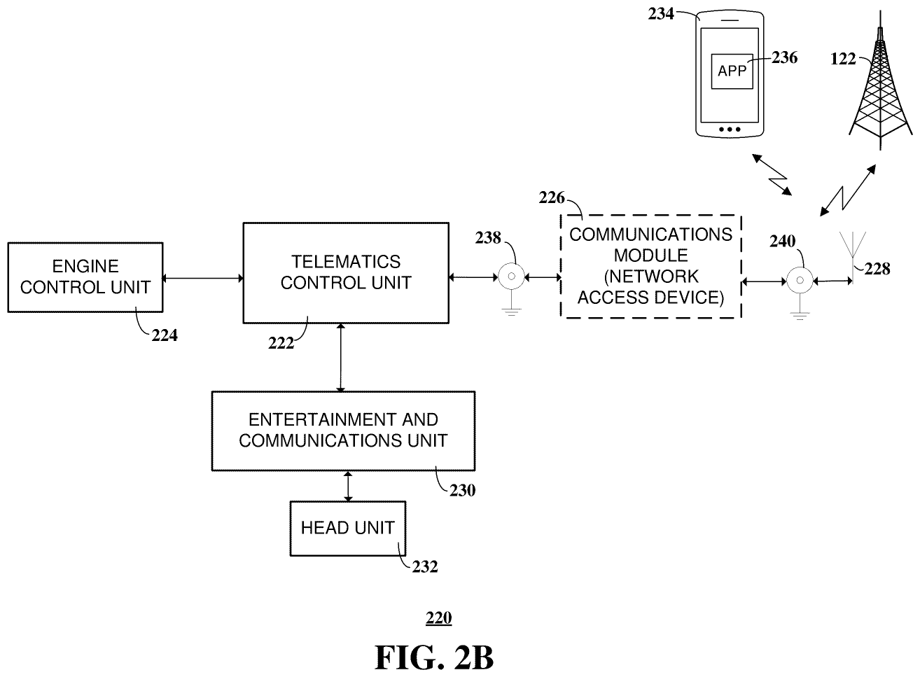

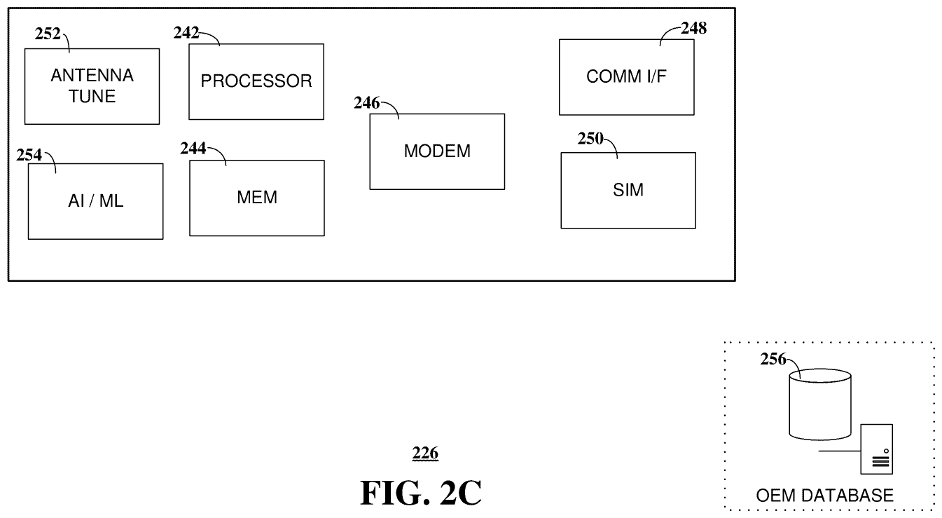

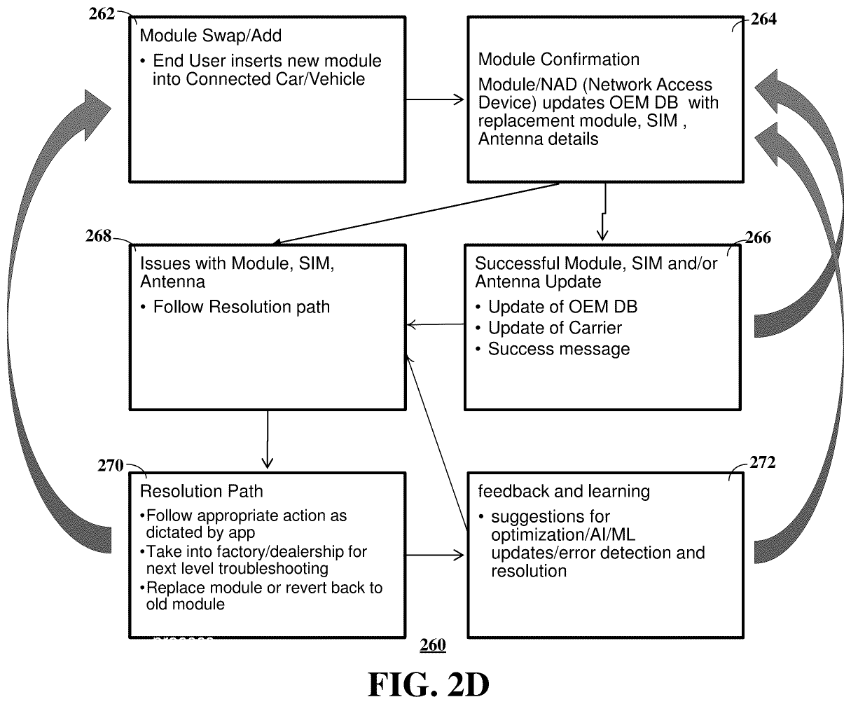

FIG. 2A is a block diagram illustrating an example, non-limiting embodiment of a system 200 functioning within the communications network 125 of FIG. 1 in accordance with various aspects described herein. The system 200 may be used to provide mobile, two-way communication services to a system such as a vehicle 202. The vehicle 202 may be a connected vehicle and be in data communication with other systems. In the example, the vehicle 202 obtains communications connectivity over a mobility network 208 of a mobile network operator or carrier.

In an example, the vehicle 202 may have access over the mobility network 208 to any network components including the public internet, for example, by means of the wireless access 120 of FIG. 1. The vehicle 202 communicates with various network equipment such as carrier billing system 204 core network equipment such as mobility management systems. Access to network features and capabilities may be controlled by data maintained by the carrier billing system 204. For example, the vehicle 202 or the owner of the vehicle 202 may be associated with an account that defines the access capabilities of the vehicle 202.

In another example, the vehicle 202 communicates over the mobility network 208 with systems suppliers and manufacturers such as manufacturer 206. Manufacturer 206 may include any supplier of components such as electronic components or software, or combinations of these, for the vehicle 202. In an example, the manufacturer 206 is an original equipment manufacturer (OEM) which designs, builds, sells and supports equipment such as the vehicle 202. In another example, the manufacturer 206 is a supplier to the OEM of components such as chipsets for controlling aspects of the vehicle 202. From time to time, aspects of the vehicle 202 or components of the vehicle 202 may need to be upgraded or replaced.

The vehicle 202 may be designed and manufactured with a defined set of components and capabilities. Such capabilities may include telematics in which one or more components of the vehicle 202 communicate with equipment of the manufacturer 206 to provide operational information about the vehicle or components of the vehicle. Such information may be used by the manufacturer 206 for identifying failure modes or design problems with the vehicle 202. The manufacturer 206 may communicate with the vehicle 202 to provide updated software, for example. The updated software may operate to correct a detected problem or failure mode of the vehicle 202. The updated software may operate to provide new or expanded capabilities for the vehicle 202.

Communication by the vehicle 202 is generally over the mobility network 208. Accordingly, the vehicle 202 incorporates a communications device 214 that enables radio communication with the mobility network 208. In an example, the communications device 214 includes a cellular radio transceiver and modem for data communications with the mobility network. In other examples, the communications device 214 may be embodied as a smartphone or other user equipment. In still other examples, the communications device 214 may be embodied as an IoT device including a sensor for detecting a condition, a controller for controlling a response, or a combination of these, along with cellular radio circuitry for communicating with the mobility network 208.

The mobility network 208 includes base stations such as base station 210 and base station 212 that enable mobile communication with mobile radios such as the communications device 214 of the vehicle 202. Communications is generally according to an established air interface standard such as 4G or LTE or 5G. Other standards such as Wi-Fi communications according to one or more IEEE 802.11 standards, Bluetooth, and others may be used for communication by the vehicle 202.

FIG. 2B is a block diagram illustrating an example, non-limiting embodiment of a connected vehicle control system 220 functioning within the communication network of FIG. 1 in accordance with various aspects described herein. The connected vehicle control system 220 may function as a part of the vehicle 202 of FIG. 2A. In the exemplary embodiment, the connected vehicle control system 220 includes a telematics control unit (TCU) 222, an engine control unit (ECU) 224, a communications module or network access device (NAD) 226, an antenna 228, an entertainment and communications unit 230 and a head unit 232. Other embodiments may include additional features and components or may be organized differently. The various components of the connected vehicle control system 220 may include any combination of hardware and software necessary to perform the required functions and to interact with other features of a vehicle such as the vehicle 202.

The telematics control unit (TCU) 222 manages connectivity aspects within a vehicle such as vehicle 202. For example, the TCU 222 routes information to the engine control unit 224 to manage ECU 224 and systems associated with the ECU 224. Further, the TCU 222 communicates with the entertainment and communications unit 230. The TCU 222 may further manage satellite navigation, external communications, and other vehicle functions. Further, the TCU 222 may receive information and data from the ECU 224 and provide information based on the received information to remote destinations. The remote destinations may include a vehicle service facility or a manufacturer (OEM) of the vehicle. The TCU 222 manages in-vehicle communications. The TCU 222 may further communicate vehicle information with a remote destination such as a network or database of the OEM, service partner or other third party.

The ECU 224 controls and monitors systems of the engine and powertrain of the vehicle. Examples include fuel injection and ignition as well as idle speed and valve timing in an internal combustion engine. The ECU may include or receive information from sensors such as an accelerator pedal position sensor, a camshaft position sensor, coolant temperature sensor, knock sensors, and others. If the vehicle is an electric vehicle (eV) with one or more electric motors providing propulsion in place of an internal combustion engine, the ECU may be supplemented with or replaced by an electric control unit. The electric control unit performs similar monitoring and control functions for the eV including battery management and charging, power output optimization, and other functions. Similar to the engine control unit, the electric control unit collects status and performance information for reporting to remote destinations. This shared information may be referred to as telematics information.

The entertainment and communications unit 230 provides access to and control of information and entertainment (sometimes referred to as infotainment) features of the vehicle. Such features include radio and media playback on audio or video systems of the vehicle, interface with navigation systems of the vehicle, and interface with remote access systems such as a user's smartphone or other device. The entertainment and communications unit 230 may interact with the head unit 232. The head unit 232 may form or incorporate a user interface including touch panel displays, switches and other controls for user access of the functions of the entertainment and communications unit 230.

The NAD 226 provides communications functionality external to the vehicle. The NAD 226 may also be referred to as a communications access module or module. In many IoT applications, the communications access module is generally referred to as a module. In automotive applications, the communications access module is generally referred to as a NAD 226 and the terms are intended to be interchangeable as used herein. Variations that are specific to one embodiment or application will be specified.

The module or NAD 226 generally includes a wireless communications module for two-way wireless communications with one or more radio access networks such as base station 122 of wireless access 120 (FIG. 1). The NAD 226 may include several radio modules for external communication, including a cellular modem for accessing a cellular network such as a 4G LTE network or a 5G network and vehicle-to-vehicle (V2X) communications; a global positioning system (GPS) receiver for receiving GPS signals from satellites; and others. The NAD 226 may include one or more subscriber identity modules (SIMs) providing personalization information such as account information associated with an account maintained by a mobile network operator. Such SIM information is used to access the mobility network through the base station 122. Further, the NAD 226 may include a Wi-Fi radio circuit for communications according to one or more standards as defined by IEEE 802.11, the Bluetooth standard, and other standards. In some embodiments, the NAD 226 may include one or more electrical connectors for direct physical interface with an external network such as a controller area network (CAN) bus of the vehicle. The components of the module or NAD 226 may be contained in a housing so that the NAD 226 is a physically self-contained device which receives electrical power and communication signals via a connector or wireless link and which is removable from the vehicle.

The module or NAD 226 is in electrical communication with the antenna 228. The antenna 228 converts electrical energy from the NAD 226 to electromagnetic energy for transmission to remote destinations such as the base station 122. Similarly, the antenna detects electromagnetic energy transmitted by a remote source such as base station 122 and converts the electromagnetic energy to electrical energy for reception, conversion and demodulation by the NAD 226.

In embodiments, a remote device such as a smartphone 234 may interact with aspects of the connected vehicle control system 220. The smartphone 234 may include one or more applications or apps such as app 236 for receiving information from the connected vehicle control system 220 or for controlling aspects of the connected vehicle control system 220. For example, the app 236 and the smartphone 234 may be operable to receive information from the TCU 222 such as telematics information, or to control functions of the TCU 222 and subsystems. In another example, the app 236 and smartphone 234 may interface with the NAD 226 to control operations of and modifications to the NAD 226. Communication between the smartphone 234 and the module or NAD 226 may be according to any suitable standard, such as cellular communications (4G LTE, 5G, etc.), Wi-Fi, Bluetooth, and others.

In accordance with some aspects described herein, the module or NAD 226 is configured as an upgradeable or replaceable module or circuit or self-contained component, including both hardware and software. The module or NAD 226 may be upgraded by replacing some or all software and data of the NAD 226. Upgrading may include an automatic process in which new software is downloaded to the NAD 226 over a wireless or other connection and aspects of the functionality of the NAD 226 are changed. Replacing the NAD 226 may involve physically removing an old NAD 226 from the vehicle such as vehicle 202 and replacing the old NAD 226 with a new NAD. The new NAD is physically and electrically compatible with the old NAD 226 and represents a substitution of the new NAD for the old NAD 226. For replacement, the NAD 226 may communicate with other components such as the TCU 222 and the antenna 228 via one or more connectors such as connector 238 and connector 240. Such connectors may be standardized such that the new NAD is a pin-for-pin replacement for the old NAD 226. In this manner, an upgrade or a replacement or swap out of the old NAD 226 can be done quickly and inexpensively by a technician without having to physically alter the vehicle.

FIG. 2C is a block diagram illustrating an example, non-limiting embodiment of a module or a network access device 226 in accordance with various aspects described herein. In the exemplary embodiment, the NAD 226 includes a processing system 242, a memory 244, a modem 246, a communications interface 248, a subscriber identity module (SIM) 250, an antenna tuning module 252 and an artificial intelligence/machine learning (AI/ML) module 254.

The module or NAD 226 is configured for communications between a vehicle such as vehicle 202 and remote destinations such as a manufacturer network of a manufacturer associated with the vehicle including, in the example, OEM database 256 (FIG. 2A). A manufacturer of the vehicle may include any supplier of components such as electronic components or software, or combinations of these, for the vehicle 202. The OEM database 256 stores information about vehicles manufactured by the manufacturer, including details about the vehicle, the equipment included with the vehicle, and historical information about the vehicle and its equipment. For example, if the vehicle is subject to a manufacturer recall for modification of hardware or software, the requirement for the recall may be stored in the OEM database 256 and information about completion of work related to the recall may be updated and stored in the OEM database upon completion. If a component of the vehicle has been upgraded or replaced, or is due for upgrading or replacement, information about the old and new components and completion of the work may be stored in the OEM database. For example, individual components may be identified by a manufacturer identifier, a model number and an individual serial number to allow an individual component to be identified and tracked. The identifier may be stored on the component, such as on a machine-readable tag or label, or in a radio frequency identification (RFID) tag. Status information based on the identifier may be tracked and updated in the OEM database 256.

In the example embodiment of the NAD 226, the processing system 242 includes one or more processors for controlling operation of the NAD 226. The processing system may respond to data and instructions stored in memory 244 or received from remote locations. The data stored in the memory may include vehicle-specific information, such as information about current equipment and capabilities and telematics information collected from the vehicle including sensors of the vehicle, for example. The data stored in the memory may further include user-specific information such as identification of a vehicle owner, a vehicle identification number (VIN) of the vehicle, and other information.

The module or NAD 226 includes communication circuitry including the modem 246 and the communication interface 248. The modem provides modulation and demodulation of radio frequency signals transmitted from or received at the NAD 226. The communication interface 248 provides front-end radio processing including frequency tuning, amplification, filtering and other functions. The communication interface 248 may connect directly to the antenna 228 (FIG. 2B) over a connector such as connector 240 and any required cabling.

Operation of the modem 246 and the communication interface 248 may be according to one or more air interface standards. The air interface standard enables reliable mobile communication between the NAD 226 and a mobility network operated by a mobile network operator (MNO), also referred to as a carrier. Examples of air interface standards include the 4G LTE standard and the 5G standard published by the 3^{rd} Generation Partnership Project (3GPP). The NAD 226 includes one or more subscriber identity modules such as SIM 250. The SIM 250 uniquely identifies an account of the MNO to enable network access and billing and to define network provisioning for the NAD 226. For example, some features associated with upgrading or replacing the NAD 226 may be enabled or limited by particular account provisioning by the carrier, by the OEM, or both. Provisioning generally defines features and attributes of a service provided to an end user by a service provider. Some provisioned features may be provided at extra cost or a subscription fee to the user.

As communication standards develop, or as subsequent generations of communication standards are published and become operational, the module or NAD 226 may be upgraded or replaced to permit the NAD 226 to continue to communicate on the mobility network, in accordance with various aspects described herein. For example, the vehicle may be built with a 4G LTE-compatible NAD 226. The NAD 226 accesses a mobility network of an MNO using 4G LTE circuitry. Over the duration of the vehicle's life, the MNO will update the network by switching over to a newer, more powerful standard such as 5G. This may include supplementing equipment of the existing, old standard with equipment such as base stations, switches, core network components and others, of the new network. Eventually, the MNO will shut down the old 4G LTE network, operating on the old standard, in favor of reassigning network infrastructure to a new standard such as 5G or even 6G equipment, when that becomes available. If the vehicle can only communicate on the old standard, the vehicle loses connectivity, even though the vehicle has many years left in its service life. This loss of connectivity can be problematic for users who may lose access to features such as navigation and voice and data communication. The loss of connectivity can be problematic for OEMs who lose access to data such as telematics information, which may be particularly valuable in the later years of a vehicle's lifetime.

Accordingly, the module or NAD 226 may be selectively upgraded or even replaced in the vehicle. In embodiments, this may be done in a mix and match approach in which the OEM, the user or another may selectively replace the NAD 226, the antenna 228, the SIM 250, or any other component that requires updating to match the advance from one communication generation to another and maintain connectivity with the improved network equipment. The selection of components to replace or upgrade may be based on any suitable factors including cost, how a vehicle is used by the user, and technological compatibility. For example, the upgrading or replacement process may include the new NAD configured for operation on the new standard or new generation informing the OEM database 256 about the upgrade. This may include providing to the OEM database details about the new NAD, a new antenna if one is being installed, new antenna characteristics or newly required antenna characteristics, and information about a new SIM if one is required.

Identifying the remaining components of the exemplary embodiment of the NAD 226 if FIG. 2C, the antenna tuning module 252 may automatically or cooperatively operate to tune an electrical connection between the NAD 226 and the antenna 228. This connection may include a connector such as connector 240 and any necessary cabling. For example, the new standard, such as 5G, may use for radio communication a set of frequencies that is different from the set of frequencies used by the old standard, 4G in this example. The new set of frequencies may include some or all of the old frequencies, with different channel assignments within the band, or a superset of frequencies, or frequencies in an entirely different band. Frequency assignment is a function of many factors including system design, license availability, and others.

To adapt the antenna 228, and an electrical connection between the NAD and the antenna 228, the antenna tuning module 252 may use any combination of hardware components and software to modify the frequencies being used, including channel assignments, and adapt electrical parameters of the connection between the NAD 226 and the antenna 228. For example, a cable impedance may need to be adjusted from an old configuration suitable for the old generation standard to a new configuration for the new generation standard. This may be required for a particular model such as a 2015 Ford Expedition or a particular vehicle design, such as a 2015 Ford Expedition built in December of 2014 according to the then-current design parameters. Additionally, this may be required for a particular vehicle, such as a 2015 Ford Expedition that was modified to move the antenna from a design location to a new location. The antenna tuning module 252 may use any suitable technique to make the necessary modification. The process may be iterative in order to make a modification, test the results and make additional modifications.

The AI/ML module 254 may monitor processes including updates and replacement of the NAD 226 to provide failure correction and error detection. This may be particularly beneficial to prevent disruption in service for the NAD, the user and the OEM. In one example, the AI/ML module 254 cooperates with the antenna tuning module 252 to tune a connection between the new NAD and the existing antenna 228. In another example, the AI/ML module 254 monitors the process of replacing or updating the NAD 226 to identify, correct and prevent failure mechanisms. Such failure mechanisms may include a hardware mismatch between the new NAD being installed and existing vehicle infrastructure, or similar software compatibility.

The AI/ML module 254 may implement any suitable artificial intelligence routine or machine learning model to perform the required function. Further, the AI/ML module 254 may be trained using any suitable, available training data. For example, as the OEM replaces NAD modules in dozens, hundreds or thousands of vehicles of a particular type or design to accommodate a new generation mobile network, the AI/ML module 254 may have access to training data from all previously installed replacements. Further, the AI/ML module 254 may be part of an overall artificial intelligence system or process of the OEM that includes both onboard components, such as the AI/ML module 254, and centralized, shared components such an AI control system located remotely at facilities of the OEM.

FIG. 2D depicts an illustrative embodiment of a method 260 in accordance with various aspects described herein. The method 260 may be used to upgrade or replace communication equipment such as a radio communications module and an antenna in a device such as a connected vehicle or an internet of things (IoT) device. A user may selectively replace or upgrade components as desired or as needed. For example, the module (or Network Access Device or NAD), the antenna, and the subscriber identity module (SIM) may all be fully replaced as a group of components. In a second example, just the module may be replaced and the antenna and SIM remain unchanged. In a third example, the module may be upgraded, meaning that software and data that control the module is replaced with new software and data, and the antenna and SIM remain unchanged. Other examples of selective component replacement may be readily imagined.

In accordance with the method 260, a highly cost-effective solution is provided to allow a vehicle or an IoT device to maintain communications connectivity with a mobility network, even in the face of substantial change in the mobility network. This can include a complete reconfiguration of the mobility network according to a new, updated generation of technology, such as 4G LTE to 5G. This is particularly cost effective in the case of management of a large number of devices that need upgrading. For example, an operator of a fleet of automobiles, each of which is a connected vehicle, can select which components of each connected vehicle should be upgraded (i.e., maintain the same hardware in place but change controlling software or firmware) and which should be replaced (i.e., old hardware replaced by new hardware). Similarly, an OEM seeking to convert a large number of vehicles manufactured with modules providing connectivity to an old standard can selectively upgrade or replace components in all the vehicles, as required. Only components that need to be replaced are replaced. Other components that can be reused with just a software or other change can be reused, reducing overall cost for the large-scale replacement. In this way, connectivity for the vehicle or IoT device is maintained in an economical manner, especially if a large number of vehicles or devices need to be managed.

In an example, a user is faced with a change from a current generation mobility network (such as 5G) to a next generation mobility network (such as 6G). The user desires that a fleet of vehicles will retain connectivity, even after the network changes. Therefore, the user must either replace or upgrade the components providing radio connectivity with the network. The user choosing to replace or upgrade components can mix-and-match the components to be used with the next generation mobility network. For example, first, the user can retain unchanged components that will function satisfactorily in the next generation network. Second, the user can modify components that need, for example, a software revision or updating, but include hardware that can still function on the next generation network. Third, the user can replace components that are no longer suitable for use on the next generation mobility network. Rather than replacing all components, only those that need replacing are swapped out.

One goal of the process including the method 260 is to maintain connectivity of the connected vehicle or other device before, during and after the process. A second goal of the process is to not lose any data or other information associated with the vehicle, the owner or user, any accounts associated with the vehicle and owner, etc. The result of the replacement or upgrade of components should be transparent to the user.

It is noted that this can be extended to any collection of devices or components. In the exemplary embodiment, a connected vehicle is equipped with discrete components including a module or NAD, an antenna and a SIM. In some examples, the SIM and module may be combined by using an embedded SIM or eSIM. The eSIM cannot be removed from the module but can be reprogrammed with updated information. In other examples, other components may be combined with the module, the antenna and the SIM and handled in the same mix-and-match manner as described herein. For example, a cable between the module and the antenna may be selectively replaced, depending on the particular antenna used.

In other examples, the device having components being upgraded or replaced is an IoT device. The IoT device may include a control module including software, a module for communication, an antenna, one or more sensors such as a camera, and a controller to be actuated remotely. In order to adapt the IoT device to a modified mobility network, a user may select which components of the IoT device are to be upgraded, such as with new software, which components of the IoT device are to be replaced with new components, and which components of the IoT device are to be maintained unchanged because they are not affected by the change to the mobility network.

The method 260 can be initiated by any suitable individual in any suitable manner. In some examples, the method 260 can be initiated by the owner of the vehicle who desires to reconfigure the connected vehicle function on the vehicle. In other examples, the method 260 can be initiated by personnel associated with the OEM or manufacturer of the vehicle. In other examples, the method 260 can be initiated by a dealer or other service technician. The user can access an application on a handheld device to manage the process. The method 260 begins at step 262.

### 1. Scenario 1: Full Module Swap and Replace

In a first scenario, all connected communication components of a connected vehicle are to be swapped or replaced by new components. In the example, the components include a module or NAD, an antenna, and a SIM. To begin the process in this example, the user inserts the new module into the connected vehicle. This may include making all appropriate mechanical connections and electrical connections, such as connections to power and ground, to a CAN bus, etc. The module may include one or more connectors adapted to mechanically mate with existing connectors of the vehicle. The old module, to be replaced, is disconnected and the new module is connected in its place.

In embodiments, if the module is connected to one or more wireless networks, appropriate network access procedures are carried out. For example, if the old module established or participated in a Bluetooth in-vehicle network, the new module may similarly establish or join the Bluetooth network. In an example, the module communicates over Bluetooth, Wi-Fi or a cellular connection with a user device such as a mobile phone or other user equipment (UE). The user associated with the UE may access an application such as app 236 operating on smartphone 234 (FIG. 2B). Through the application, the user may initiate and control the process of activating the new module. Alternatively, activation of the module may be generally automated once initiated by the user.

Further, the new module contacts the mobility network in accordance with the air interface standard. In an example, the modem or other radio circuitry of the new module receives a downlink transmission from a base station of the mobility network and in response initiates an uplink transmission to register with the mobility network and begin a session. Since air interface standards are generally backwards compatible, the module operative on a next generation mobility network may communicate with both the next generation network or a current generation network, if the current generation network remains functioning. The module may be designed to have a bias or preference for the next generation network.

At step 264, the new module accesses a network and equipment of the OEM to confirm module information. The OEM equipment may include one or more databases of information related to customers, previously built and sold vehicles, and ongoing maintenance, repair and performance data. In the example, the module or NAD accesses a database (DB) of the OEM to provide detailed information about the new module, the new SIM and the new antenna. For example, the vehicle may be identified in any suitable manner, such as through its unique VIN number. Information about the vehicle may be stored in the OEM database in association with the VIN number. During step 264, the information associated with the module, the SIM and the antenna is communicated to the OEM database. In embodiments, this information communication may be done by communication between the module and the application on the UE device and between the UE device and the mobility network and to the OEM network. Any other combination of communication channels may be used, such as a wireline connection between a connector of the module and the UE or other equipment.

In an example, in step 264, the module or NAD reports to the OEM database a frequency band set supported by the new module. The frequency band set is a set of frequencies assigned to by the mobility network for radio communication on the mobility network. The frequency band set may differ for different networks, different generations of networks, and different customer accounts and UE devices such as the module. In this example, the original module or old module supported a band set A, where band set A is a first predetermined set of frequencies, or first channels, used by the previous generation network. The new module reports that it supports band set B, where band set B is a second predetermined set of frequencies, or second channels, used by the next generation network. In an example based on FIG. 2C, the processing system 242 may retrieve from the memory 244 information about the frequency band set used by the communications interface 248 and the modem 246 of the NAD 226 and communicate that information for receipt and storage at the OEM database. In some cases, the old antenna may support just band set A or may support band set A plus some or all of the frequencies or channels of band set B. The OEM database may note any overlap between the old band set A and the new band set B.

The OEM database or more generally the OEM network has the responsibility of ensuring that the new module is compatible with the vehicle, the antenna and with the systems of the OEM. Further, the OEM systems map information of the vehicle to the new module to ensure that no information such as vehicle historical data or account data is lost in the process of upgrading or replacing.

Further in step 264, information of the old SIM is mapped to the new SIM or the new module and with the OEM database. For example, the new module, such as the modem 246 of the module (FIG. 2G), verifies with the OEM database and synchronizes information of the new SIM with the OEM database. SIM information of interest may include account information for network access and identification information such as the international mobile subscriber identify (IMSI) number and secure authentication information. The new phone number or SIM associated with the new module is updated in the OEM database. Further, all vehicle details, user profile details and module details are updated in the database and associated with, for example, the VIN of the vehicle. In some embodiments, referring to FIG. 2B, the module or NAD 226 communicates with the TCU 222 to obtain detailed information of the vehicle and the user. The TCU 222 informs the module or NAD 226 of the VIN and other details which are relayed to the OEM database 256 (FIG. 2C).

Further at step 264, an antenna updating process occurs. The module maps its capabilities against the capabilities of the new antenna. In the noted example, the new module operating on band set B confirms that the new antenna is suitably operational on band set B as well. In accordance with the embodiment of FIG. 2C, the antenna tuning module 252 operates to tune the connection between the new module and the antenna to ensure reliable performance. The antenna tuning module 252 may perform an automatic test operation in response to initiation by the module. The antenna tuning module 252 may send instructions to adjust parameters such as resistances and capacitances to adjust where the antenna is tuned.

In an example, the antenna has a wide frequency range and includes multiple antenna elements. A first antenna element supports a frequency range of 400 MHz to 1 GHz. A second antenna element supports a frequency range of 1.5 GHz to 2.5 GHz. Each antenna can be individually adjusted or tuned. In an example, the old generation communication network used frequencies in the range 700-800 MHz but the new generation communication network uses frequencies in the range 850-900 MHz. The antenna element that handles that range can be tuned or adjusted to optimize performance at the new frequency range. If the antenna includes other antennas for other radio communication, such as Wi-Fi and Bluetooth or others, such other antennas may be tuned as well.

In embodiments, when the new module is inserted or initiated in the vehicle at step 262, the new module may interrogate other system components to learn where the existing antenna is current tuned and then adjust that tuning, if necessary. For example, the new module, upon initiation of communication through the application to the OEM database, may collect old module status information which may include old module frequency assignments. The new module may compare the old module frequency assignments with frequency assignments for communication by the new module with the next generation network and, if necessary, initiate an antenna tuning routine. In another example, the application running on the UE device may have pre-stored the appropriate frequency range for the new network to be used for retuning. The application may also store antenna tuning parameters for use by the antenna tuning routine.

Further in step 264, the module communicates confirmation information to the OEM database. The confirmation information confirms that each antenna element has been tuned to an acceptable range of frequencies. Information about the successful tuning and the tuned ranges of frequencies or channels is communicated to the OEM database.

### 2. Scenario 2: Module Upgrade; Old Module Remains in Vehicle.

In a second scenario, rather than replacing all components, just the module or NAD is upgraded by installing a new module in the vehicle. The old module remains in the vehicle but is disconnected and may be disabled. Other components, such as the antenna and SIM, remain unchanged.

In this second scenario, initially the operation of step 264 are performed and the new module is installed in the vehicle. Further, component connections to the old module are disabled, for example, by a module update routine. Connections may be physically transferred from the old module to the new module, such as by plugging an antenna cable from the old module into the new module. Connectivity to the new module is confirmed. This ensures that even if the old module remains in the vehicle, it is not primarily functional and the new module takes operational precedence over the old module. Step 264 is completed to confirm successful operation of the module according to the new software.

### 3. Final Check and Update

Once the installation and operation of the module or IoT device are successfully completed at step 264, at step 266 a final check and updating of the connected communication system are completed. Step 266 may include a process of the module or NAD sharing information about the update with other vehicle components such as the head unit 232 and confirming wireless or wireline connectivity with other vehicle components. For example, the update to the new generation mobility network may provide additional or new functionality for a user of the vehicle and the head unit should be updated to provide access to that new functionality. The process of updating the module of step 264 may be followed by updating the head unit or other components.

Further, step 264 may include a final confirmation operation. The confirmation operation may be performed manually or automatically as a subprocess of the updating operation for the module. Any errors may be flagged for further attention. Successes are similarly indicated. The module may communicate with the OEM database to confirm the module details, antenna details, vehicle details and user details are updated and correct in the OEM system. If all updating and replacing has occurred successfully, the new module is formally accepted or verified in the system including the vehicle and the OEM database. In embodiments, any stored details or data associated with the old module are archived at the OEM database or similar location. Preferably, the old module details are not deleted but remain available if needed. This could apply, for example, if the old module needs to be reused or reconnected, such as if the new module does not function properly.

Further at step 264, the mobile network operator (MNO) or carrier associated with the mobility network is notified of the updating or replacing. For example, the account of the vehicle or user may be associated with a particular SIM identity which must be updated in records of the MNO. This ensures that any billable services provided by the MNO continue to be provided and billed for, for example.

Still further at step 264, one or more success messages may be generated at completion of the processes of step 264. For example, if the process is performed by an application on a UE device of a user or technician, a success message with text or graphical information may be displayed to the individual on the user interface of the UE device. Further success messages may be communicated to the OEM database to fully confirm completion of the updating or replacing operation.

If all installations and checks are successfully completed, control returns to step 264 as indicated by the arrow in FIG. 2D. However, if an error or inconsistency is detected, control may proceed to step 268 and a real-time adaptation process may be initiated.

### 4. Real-Time Adaptation Process.

Step 268 may be performed if operational issues are detected for the module, the SIM, the antenna or another component of the module or an IoT device. In embodiments, the real-time adaptation process of step 268 may be performed in conjunction with an application operating on a UE device of a user such as the vehicle owner or a service technician. The application may display a checklist or a procedural flow for use by the user to follow to troubleshoot the installation.

In an example, of such a procedural flow, each component may be considered in turn. Initially, the module is evaluated for issues. First, the procedure of step 268 determines if the module is supported or not by the connected vehicle system. Selection and usage of the correct module, including the correct modem for radio communication, is a threshold issue for troubleshooting. This may be detected by entering a unit serial number for the module or automatically receiving and reading identification information by the application on the UE device, or by any other convenient technique. If it is determined that the wrong module has been selected, or that the selected module is not supported by the system, a resolution path is provided, step 270. In an example, the application on the UE device may identify the particular module mismatch and specify clearly what module should be used. Such specification may be provided in any suitable manner, such as listing part numbers of acceptable module units or providing photographs or graphical images of acceptable modules on the user interface of the UE device.

Second, the procedure of step 268 determines if there is a failure of handshaking communication between the module and the other approved systems such as the network of the OEM. For example, a software issue may prevent updating and installation. In that case the resolution path of step 270 includes providing an error message on the user interface of the UE device by the application which manages the process. In another example, the OEM database or another source or destination for data from the module may be not accessible, at least temporarily. Again, a resolution path including an error message is provided on the UE device in accordance with step 270.

Third, the procedure of step 268 determines if there is an error or other issue with the SIM of the connected communication system. For example, the SIM may not be activated properly on the mobility network so that the network does not recognize the SIM, or the SIM fails when trying to connect to the network due to damage or another reason. A resolution path at step 270 may include instructing the user, via the user interface of the UI device, to replace the new modem of the new module with the old modem of the old module, the unit has been added.

Fourth, the procedure of step 268 determines if there is an otherwise undetected hardware issue with components of the module. If such as issue is detected, the UE device may display to the user an appropriate message indicating that there exists a connectivity, hardware or damage issue with the module. A resolution path at step 270 may be provided of replacing the module. This check may serve as a default option for step 268 if no other error mechanism is identified. In addition, if the procedure of step 268 identified issues are not resolvable, the resolution path of step 270 may include suggestions to follow any appropriate action as dictated by the application operating on the UE device, taking the device to the OEM factory or a dealership or other service facility for next-level troubleshooting, completely replacing the new module with another module or reverting back to the old module. The method 260 may be restarted with the old module or with a different new module.

Step 268 may further include troubleshooting issues with the antenna of the connected vehicle communication system. Such issues may occur in which the antenna does not successfully connect to the module. This may occur, for example, because there is a functional, mechanical or electrical incompatibility, because the module is damaged or has functional issues that need to be resolved, or if the antenna has a mechanical, electrical, hardware or cabling issue. In each of these instances, a resolution path may be provided, step 270. In some examples, the resolution path may involve displaying an error message by the application on the UE device and provided suggested troubleshooting steps to resolve the problem.

In another example, the antenna may function to a degree but fail to meet all performance parameters. In one example, the antenna does not support the required frequency range. In another example, during an antenna tuning operation, the antenna may not be able to be tuned to one or more ranges specified for the new module on the new communication standard. In another example, the antenna may be able to tune to the required ranges, but antenna performance is poor. This may be measured in any suitable manner and compared with any suitable threshold.

For any apparent antenna issue that is identified, a resolution path may include determining if the issue is truly an antenna issue or if the issue may be actually a module issue. If a module issue is suspected, the procedure of step 268 to test and identify module issues may be followed. If the issue is identified to be an antenna issue, an external antenna may be used. Moreover, for a true antenna issue, the resolution path may include confirming all connections between the module and the antenna. Following the recommendation of a resolution path and resolution, control may return to step 262 and indicated in FIG. 2D.

Following implementation of a resolution on a provided resolution path, step 270, a feedback loop may be implemented at step 272. The feedback loop of step 272 attempt to learn from the troubleshooting process of steps 268 and 270 and identify what resolution steps are successful at resolving particular problems. In one aspect, based on such learned success paths, the error messages and suggested resolutions proposed by the application to the user may be updated to reflect the learning, as indicated by arrows from step 272 to step 268 and step 264. For example, if the user manually implemented a particular process to improve antenna tuning, step 272 would attempt to automate the learned process so that it can be implemented automatically if the issue is encountered in the future.

In some examples, an artificial intelligence (AI) or machine learning process may control the process of determining suitable feedback and providing modifications to established procedures of step 268 and step 270. Any suitable AI or ML process may be used to drive the feedback process to improve issue identification and resolution.

Features of the method 260 of FIG. 2D may be extended to include other unique capabilities. For example, operation of the connected vehicle capability may be used to detect a theft or other unauthorized use of the vehicle. For example, during usage of the vehicle, the carrier and OEM receive and process substantial data about the vehicle and the user. The data may be used, with user permission, to develop a profile of the user the relates user identity, vehicle identification, SIM identification information and user activity. Persistent or repeated user activity may be indicated in telematics information provided to the OEM. The aggregated data from the connected vehicle system may be mined to identify user activities and more importantly, activities by other than an authorized user. In this manner, the connected vehicle communication system may be used to identify a theft or other unauthorized use of the vehicle.

Commercial vehicles, including cars, trucks, heavy equipment and agricultural equipment, released prior to the year 2025 will likely be active on mobility networks using 4G LTE, 5G or some combination of those. However, such vehicles need a plan to maintain connectivity well into the time frame of 2030 to 2040. At that time, however, 6G and 7G communication networks will be available or prevail. The OEM and the customer will require cost-effective, modularized upgrades, and a method for making such upgrades, for better connectivity and reliability on the future mobility networks.

The disclosed system and method provide substantial benefits to equipment manufacturers, mobile network operators and to customers of each. This system provides an end-to-end management system for the upgrade of a connected vehicle or IoT device module, SIM and antenna. Further, the system and method provide for real time adaptation to address potential pathway and progression issues for future support that allows the end user to understand errors and their resolution. The system and method provide the ability to carry forward with older wireless technology as evolution occurs more frequently than car and other vehicle replacement occurs. The disclosed system and methods support a flexible design, a modular approach and ready customization for customers. The system and method enable reuse of existing antennas and available hardware in a connected vehicle communication system. In embodiments, the disclosed module may find optimal settings and connectivity with the mobile network operator or carrier communication system.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

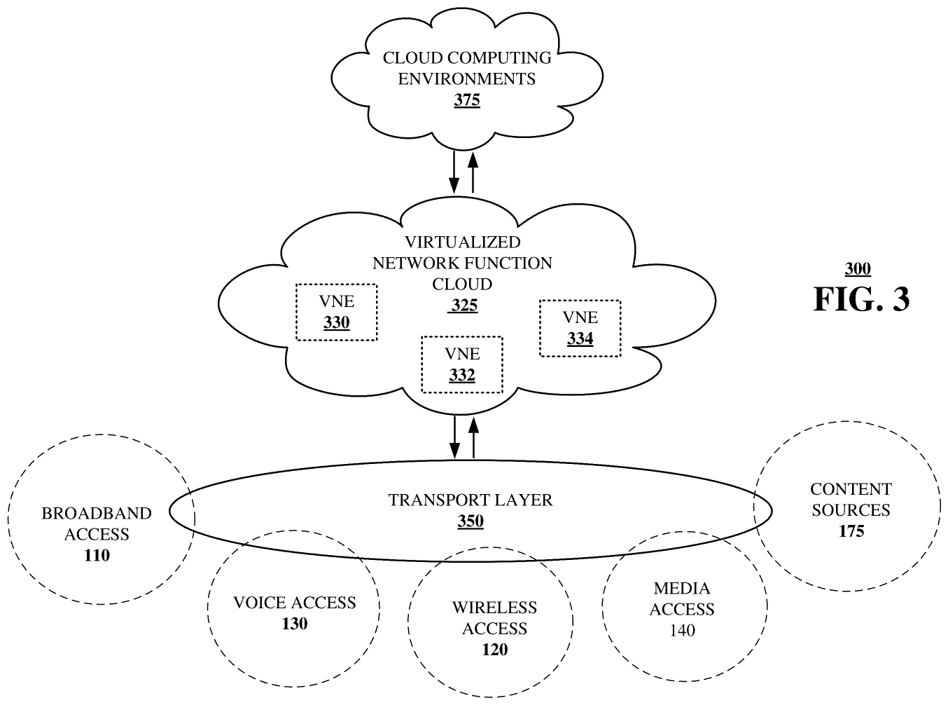

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, and method 260 presented in FIG. 1, FIG. 2A, FIG. 2B, FIG. 2C, FIG. 2D and FIG. 3. For example, virtualized communication network 300 can facilitate in whole or in part communicating vehicle data of a vehicle or Internet of Things (IoT) device data to a remote location such as a manufacturer, modifying communications components to enable future communications on a next-generation mobile network, and automatically confirming the modification.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

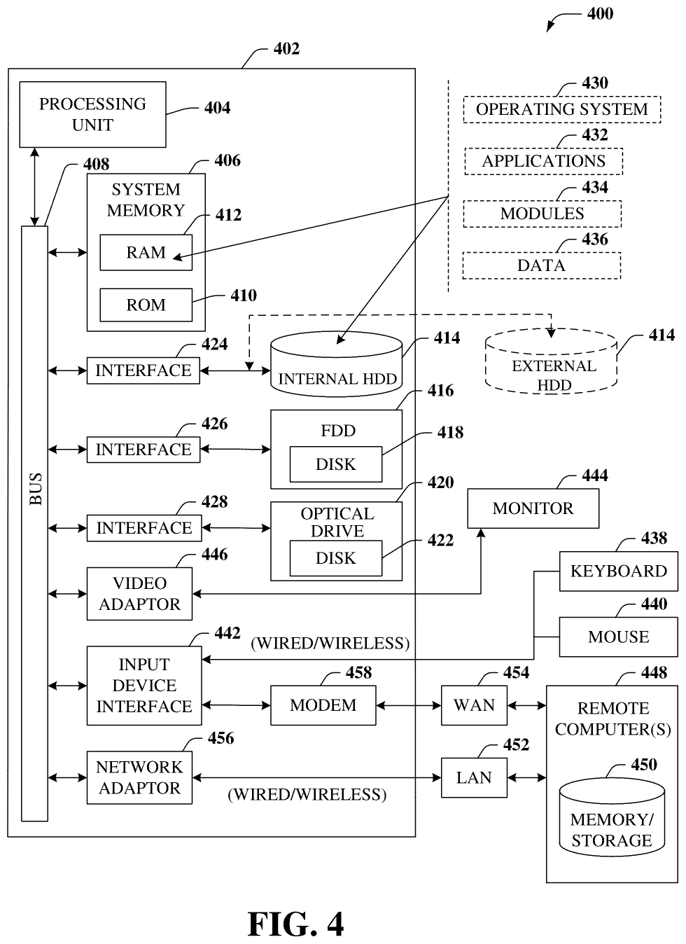

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, access point or base station 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part communicating vehicle data of a vehicle or Internet of Things (IoT) device data to a remote location such as a manufacturer, modifying communications components to enable future communications on a next-generation mobile network, and automatically confirming the modification.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

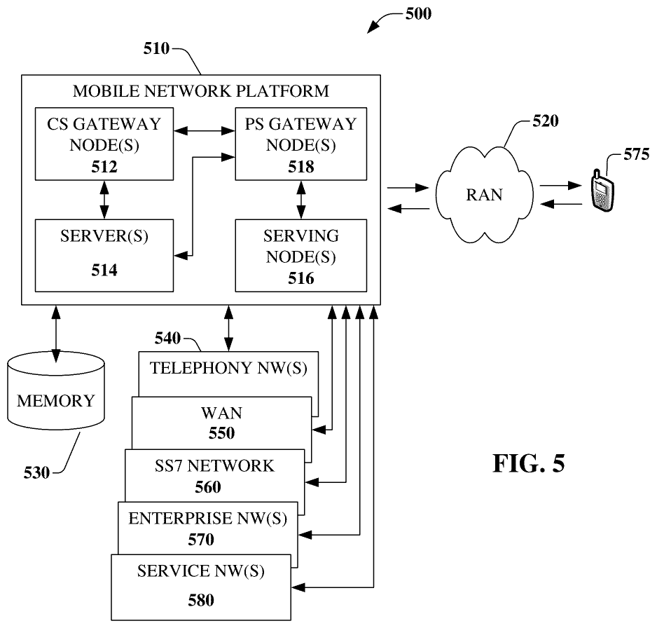

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part communicating vehicle data of a vehicle or Internet of Things (IoT) device data to a remote location such as a manufacturer, modifying communications components to enable future communications on a next-generation mobile network including a mobile platform such as the platform 510, and automatically confirming the modification. In one or more embodiments, the mobile network platform 510 can generate and receive signals transmitted and received by base stations or access points such as access point or base station 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

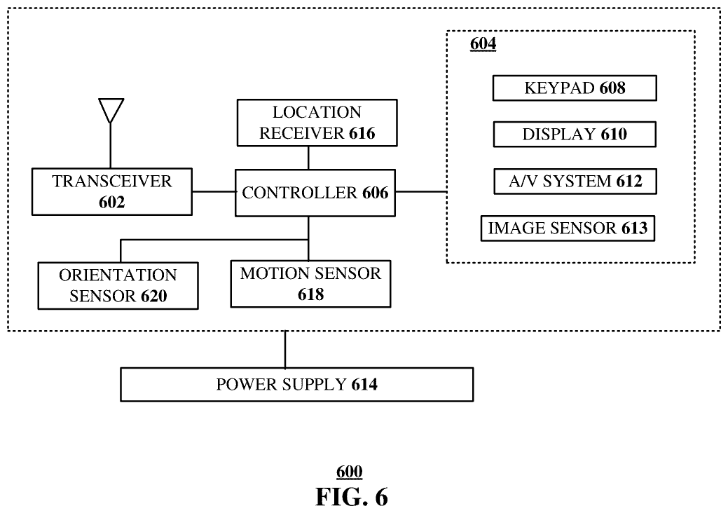

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part communicating vehicle data of a vehicle or Internet of Things (IoT) device data to a remote location such as a manufacturer, modifying communications components to enable future communications on a next-generation mobile network, and automatically confirming the modification.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
modifying one or more components of a connected vehicle communication system of a vehicle, the connected vehicle communication system operative to communicate vehicle data with network equipment of a service provider over a mobile network of a mobile network operator;
confirming, by a processing system including a processor, operational connectivity among the one or more components of the connected vehicle communication system; and
communicating, by the processing system, to the network equipment of the service provider, information confirming a successful modification of the one or more components of the connected vehicle communication system.

2. The method of claim 1, wherein the modifying the one or more components of the connected vehicle communication system comprises:
upgrading, by the processing system, operating software of a communications module of the connected vehicle communication system.

3. The method of claim 2, wherein the modifying the one or more components of the connected vehicle communication system comprises:
replacing an antenna of the connected vehicle communication system with a new antenna.

4. The method of claim 3, further comprising:
confirming, by the processing system, functional connectivity between the communications module and the new antenna of the connected vehicle communication system.

5. The method of claim 4, further comprising:
tuning, by the processing system, a connection between the communications module and the antenna of the connected vehicle communication system to ensure reliable operation of the connected vehicle communication system on the mobile network of a mobile network operator according to a future mobile communications standard.

6. The method of claim 1, wherein the modifying the one or more components of the connected vehicle communication system comprises:
upgrading, by the processing system, a subscriber identify module of the connected vehicle communication system, wherein the upgrading comprises providing, to the subscriber identify module, information for communicating on a next-generation mobile communication network of the mobile network operator.

7. The method of claim 6, wherein the modifying the one or more components of the connected vehicle communication system comprises:
replacing a communications module of the connected vehicle communication system with a next-generation communication system operable for communication on the next-generation mobile communication network of the mobile network operator.

8. The method of claim 7, wherein the modifying the one or more components of the connected vehicle communication system comprises:
replacing an antenna of the connected vehicle communication system with a new antenna, the new antenna adapted for communication with the next-generation mobile communication network of the mobile network operator.

9. The method of claim 1, wherein the connected vehicle communication system is operative to communicate telematics data of the vehicle with network equipment of an original equipment manufacturer (OEM) of the vehicle over the mobile network of the mobile network operator.

10. The method of claim 9, wherein the modifying the one or more components of a connected vehicle communication system comprises:
modifying the one or more components of the connected vehicle communication system from communication on an old mobile communication network of the mobile network operator to communication on a new mobile communication network of the mobile network operator.

11. The method of claim 9, further comprising:
communication information about the modifying of the one or more components to the network equipment of the OEM of the vehicle over the mobile network of the mobile network operator.

12. A device, comprising:
a processing system including a processor; and
a memory that stores executable instructions that, when executed by the processing system, facilitate performance of operations, the operations comprising:
communicating information about a modification of a connected vehicle communication module associated with a vehicle, wherein the communicating comprises providing data to network equipment of a manufacturer of the vehicle including the connected vehicle communication module, wherein the connected vehicle communication module is operative to provide connected vehicle data to the network equipment of the manufacturer over a mobility network of a mobile network operator;
modifying the connected vehicle communication module according to the modification to conform future connected vehicle communications of the connected vehicle communication module to a future mobile communications standard of the mobility network of the mobile network operator; and
communicating, to the network equipment of the manufacturer, information confirming a successful modification of the connected vehicle communication module.

13. The device of claim 12, wherein the modifying the connected vehicle communication module comprises:
replacing current operating software of the connected vehicle communication module of with upgraded software to enable communication according to the future mobile communications standard of the mobility network of the mobile network operator.

14. The device of claim 12, wherein the modifying the connected vehicle communication module comprises:
replacing the connected vehicle communication module with a replacement communication module, the replacement communication module operative to enable communication according to the future mobile communications standard of the mobility network of the mobile network operator.

15. The device of claim 12, wherein the operations further comprise:
modifying the connected vehicle communication module, forming a modified communication module; and
confirming operational connectivity between the modified communication module and an antenna for reliable communication according to the future mobile communications standard of the mobility network of the mobile network operator.

16. The device of claim 15, wherein the communicating, to the network equipment of the manufacturer, information confirming a successful modification of the connected vehicle communication module comprises:
communicating, to the network equipment of the manufacturer, information about the modified communication module, information about the antenna, and information about a subscriber identity module, to enable future communication of vehicle data of the vehicle from the modified communication module to the network equipment of the manufacturer.

17. A non-transitory machine-readable medium, comprising executable instructions that, when executed by a processing system including a processor, facilitate performance of operations, the operations comprising:
communicating vehicle information of a vehicle to a manufacturer of the vehicle, wherein the communicating comprises communicating the vehicle information between a connected vehicle communications system of the vehicle and a mobility network of a mobile network operator;
modifying one or more components of the connected vehicle communications system to conform to a next-generation communication standard of the mobility network, forming a modified communications system;
automatically confirming operation of the modified communication system; and
communicating to the manufacturer of the vehicle information about the modified communications system.

18. The non-transitory machine-readable medium of claim 17, wherein the operations further comprise:
receiving, from an application operating on a user equipment device, control information for performing modifications on the one or more components of the connected vehicle communications system, wherein the user equipment device is in communication with the mobility network; and
providing, to the application operating on the user equipment device, confirmation information about the modified communications system.

19. The non-transitory machine-readable medium of claim 17, wherein the communicating the vehicle information of the vehicle to the manufacturer of the vehicle comprises:
communicating telematics information of the vehicle to the manufacturer of the vehicle.

20. The non-transitory machine-readable medium of claim 17, wherein the modifying the one or more components of the connected vehicle communications system comprises:
receiving updated software for a communications module of the connected vehicle communications system, the updated software operable to enable radio communication by the communications module according to the next-generation communication standard of the mobility network; and
installing the updated software for subsequent control of the communications module.
